(19) United States
(12) Patent Application Publication
(10) Pub. No.: US 2026/0261216 A1
(43) Pub. Date: Sep. 3, 2026

(54) A VOLTAGE CONVERTER AND METHOD OF CONVERTING VOLTAGE

(71) Applicant: YASA Limited, Oxfordshire (GB)

(72) Inventors: Simon David HART, Powys (GB); Daniel RENDELL, Oxfordshire (GB); Chinmaya RAJIV JOSHI, Warwickshire (GB); Esat Dervish KUTBAY, Oxfordshire (GB)

(21) Appl. No.: 18/993,146

(22) PCT Filed: Jul. 11, 2023
(86) PCT No.: PCT/EP2023/069164

§ 371 Date: Jan. 10, 2025

(30) Foreign Application Priority Data
Jul. 11, 2022 (GB) 2210169.5

(51) Int. Cl. H02M 7/487; H02M 1/00; H02M 7/5395

(52) U.S. Cl. CPC H02M 7/487; H02M 1/0048; H02M 7/5395

(57) ABSTRACT

We describe a converter for generating a multi-phase output voltage that uses a three-level converter having Upper pairs of switches (Upper and Mid-Lower) and Lower pairs switches (Lower and Mid-Upper) arranged between positive and negative DC input voltages and an Intermediate DC voltage. A controller controls the Upper and Lower pairs of switches using PWM over a plurality of PWM periods to generate the multi-phase AC output voltages. For each PWM period, the controller controls the respective Upper or Lower pair of switches to apply respectively either a positive or a negative offset voltage simultaneously to each of the phase outputs, wherein the positive and negative offset voltages represent an average peak to peak voltage for the phase output voltage that is offset respectively positively or negatively from the intermediate DC voltage. Advantageously, conduction losses may be reduced when the intermediate DC voltage not the same as the average phase voltage.

### FIELD OF THE INVENTION

The present invention relates to a converter and method for generating a multi-phase voltage for powering an electrical machine, for example for powering a motor or generator.

### BACKGROUND OF THE INVENTION

There is a general move away from internal combustion engines to more electric and fully electric vehicles. The automotive industry has built a reputation on reliability and technical innovation and the rapid move to more electric has led to demands on maximising many aspects of electric power supplies and drives. Power supplies, inverter/rectifier/converters, switching circuitry, controls and passive elements are critical components in electric drives and their reliability of paramount importance. Minimising cost of ownership whilst maximising reliability and efficiency across all parts of transient/model drive cycles is driving innovation.

Two level inverters produce an alternating current (AC) output waveform by using pulse width modulation (PWM) applied to semiconducting switches between two voltage levels. For every switching period the phase spends a time period connected to a +DC voltage and a time connected to a −DC voltage. The ratio of these times determines the voltage output in the AC waveform.

Whereas two level inverters have good efficiency when working under heavy loads i.e., a substantial proportion of the available voltage range, they are inefficient when operating at light loads where switch losses dominate. Switching also causes disturbances (ripple) on the DC supply voltage which can adversely affect other equipment, and to counter this, a DC capacitance rated for full voltage range is often used to smooth, switch induced ripple disturbances, and provide a local reservoir of energy.

Three level inverters are so called because they operate switches using PWM between three voltage levels. Upper and lower bounding voltages are as for two level operation, and the third supply point is mid-way/mid-voltage between these two bounds.

An intermediate voltage level is supplied by capacitor voltage dividers, which because each capacitor sees only a proportion of the full range voltage of a two-level inverter, the capacitors can be smaller of lower specification and cost.

Though three level inverters can be used over the full the voltage range, there is benefit in operating at low loads to reduce mid-voltage switch and series capacitor specifications. Three level inverters are usually neutral point clamped (NPC) to protect lower specified components.

In our previous application (GB2203651.1), we proposed a converter having a three-level topology where the mid-level switches had a lower voltage and current rating when compared to the Upper and Lower switches. A consequence of such an arrangement is that the mid-level switches in the three-level topology will have a different on-state resistance (since they have different, lower, ratings), and thus conduction losses between the Upper or Lower switches and the mid-level are unbalanced.

When the desired phase output voltage is reduced in such a three-level topology, the mid-level switches spend more time being on. As such, the conduction losses increase as the output voltage (and modulation index) is reduced, leading to a decrease in the efficiency of the system.

We have therefore appreciated the need of a converter that has the benefits of three-level converter techniques for use across the whole operating range of the three-level converter.

### SUMMARY OF THE INVENTION

The present invention therefore provides a method of generating a multi-phase output voltage, and a converter for generating a multi-phase output voltage, for driving an electrical machine in accordance with the independent claims appended hereto.

Further advantageous embodiments are also provided in accordance with the dependent claims, also appended hereto.

We describe a converter for generating a multi-phase voltage for powering an electrical machine, comprising: inputs for receiving a positive DC input voltage and a negative DC input voltage; a plurality of AC outputs, one per phase, for outputting a multi-phase AC output voltage for driving an electrical machine; for each phase, a plurality of switches arranged between the DC inputs and the respective AC phase output in a t-type arrangement, the t-type arrangement comprising an upper switch coupled between a positive DC input and the respective AC phase output, a lower switch coupled between the respective AC phase output and negative DC input, and a mid-upper switch and a mid-lower switch coupled between the AC phase output and an intermediate DC voltage, the switches being arranged in respective upper and lower pairs of switches, the upper pair comprising the upper and mid-lower switches and the lower pair of switches comprising the lower and mid-upper switches, and the intermediate DC voltage being a voltage between the positive and negative DC input voltages; an input for receiving data representing a required phase voltage demand for the electrical machine; and a controller for controlling each of the switches using Pulse Width Modulation (PWM) over a plurality of PWM periods to generate the multi-phase AC output voltages for an electrical machine, wherein the controller is configured, for each PWM period, to: control the respective Upper or Lower pair of switches to apply respectively either a positive or a negative offset voltage simultaneously to each of the phase outputs, wherein the positive and negative offset voltages represent an average peak to peak voltage for the phase output voltage that is offset respectively positively or negatively from the intermediate DC voltage.

Advantageously, conduction losses may be reduced when the intermediate DC voltage is not the same as the average phase output voltage.

Controlling the respective Upper or Lower pair of switches to apply respectively the positive or negative offset voltage may comprise: determining the positive and negative offset voltages to apply to each of the phase output voltages based on one or more of an offset buffer voltage, an output phase voltage demand, the negative DC input voltage, the positive DC input voltage and an output load power factor, wherein the offset buffer voltage represents a minimum voltage difference between a peak phase output voltage and the respective positive and negative DC input voltages.

Controlling the respective Upper or Lower pair of switches to apply respectively the positive or negative offset voltage may comprise: determining a positive and negative intermediate target voltage based on one or more of the positive or negative offset voltage, the negative DC input voltage, the positive DC input voltage, the phase voltage demand, an intermediate target buffer voltage, and a frequency of the intermediate DC voltage, wherein the positive and negative intermediate target voltages represent a target voltage deviation of the intermediate DC voltage.

In either case, the controller may apply the positive or negative offset voltage when a difference between the respective positive or negative offset voltages and the intermediate DC voltage is greater than a threshold voltage.

The controller may determine which of the positive offset or negative offset voltages to apply for a first PWM period based on the voltage difference between the positive offset voltage and the intermediate DC voltage, and the negative offset voltage and the intermediate DC voltage. When the controller applies the positive or negative offset voltage for the first PWM period, the controller may be configured to apply the positive offset voltage when the difference between the positive offset voltage and the intermediate DC voltage is greater than the difference between the negative offset voltage and the intermediate DC voltage, and wherein the controller may be configured to apply the negative offset voltage when the difference between the negative offset voltage and the intermediate DC voltage is greater than the difference between the positive offset voltage and the intermediate DC voltage.

For subsequent PWM periods, when the controller controls the Upper pair of switches to apply the positive offset voltage and wherein when the intermediate DC voltage approaches the positive intermediate target voltage, the controller may be configured to apply a negative offset voltage to the phase output voltage by controlling the Lower pair of switches.

For subsequent PWM periods, when the controller controls the Lower pair of switches to apply the negative offset voltage and wherein when the intermediate DC voltage approaches the negative intermediate target voltage, the controller may be configured to apply a positive offset voltage to the phase output voltage by controlling the Upper pair of switches.

When the controller switches between applying the positive offset voltage and negative offset voltage, the controller may control the Upper and/or Lower pair of switches to apply a slew to the offset voltage between the positive and negative offset voltages.

The intermediate DC voltage may be provided by capacitor voltage dividers arranged between the positive DC input and the negative DC input. Alternatively, the intermediate DC voltage is provided by a second DC source.

We also describe a method for generating a multi-phase voltage for powering an electrical machine, comprising: receiving a positive DC input voltage and a negative DC input voltage; receiving data representing a required phase voltage demand for the electrical machine; controlling a plurality of switches using Pulse Width Modulation (PWM) over a plurality of PWM periods to generate the multi-phase AC output voltages for an electrical machine, the plurality of switches being arranged in a plurality of groups, one per phase, wherein for each phase the group of switches are arranged between the DC inputs and a respective AC phase output in a t-type arrangement, the t-type arrangement comprising an upper switch coupled between a positive DC input and the respective AC phase output, a lower switch coupled between the respective AC phase output and negative DC input, and a mid-upper switch and a mid-lower switch coupled between the AC phase output and an intermediate DC voltage, the switches being arranged in respective upper and lower pairs of switches, the upper pair comprising the upper and mid-lower switches and the lower pair of switches comprising the lower and mid-upper switches, and the intermediate DC voltage being a voltage between the positive and negative DC input voltages; and outputting the multi-phase AC output voltages, for driving an electrical machine, wherein for each PWM period, controlling a plurality of the switches comprises: controlling the respective Upper or Lower pair of switches to apply respectively either the positive or negative offset voltage simultaneously to each of the phase outputs, wherein the positive and negative offset voltages represent an average peak to peak voltage for the phase output voltage that is offset respectively positively or negatively from the intermediate DC voltage.

Advantageously, conduction losses may be reduced when the intermediate DC voltage is not the same as the average phase output voltage.

Controlling the respective Upper or Lower pair of switches to apply respectively the positive or negative offset voltage may comprise: determining the positive and negative offset voltages to apply to each of the phase output voltages based on one or more of an offset buffer voltage, an output phase voltage demand, the negative DC input voltage, the positive DC input voltage and an output load power factor, wherein the offset buffer voltage represents a minimum voltage difference between a peak phase output voltage and the respective positive and negative DC input voltages.

Controlling the respective Upper or Lower pair of switches to apply respectively the positive or negative offset voltage may comprise: determining a positive and negative intermediate target voltage based on one or more of the positive or negative offset voltage, the negative DC input voltage, the positive DC input voltage, the phase voltage demand, an intermediate target buffer voltage, and a frequency of the intermediate DC voltage, wherein the positive and negative intermediate target voltages represent a target voltage deviation of the intermediate DC voltage.

The positive or negative offset voltage may be applied when a difference between the respective positive or negative offset voltages and the intermediate DC voltage is greater than a threshold voltage.

Which of the positive offset or negative offset voltages to apply for a first PWM period may be based on the voltage difference between the positive offset voltage and the intermediate DC voltage, and the negative offset voltage and the intermediate DC voltage.

When the positive or negative offset voltage is applied for the first PWM period, the positive offset voltage may be applied when the difference between the positive offset voltage and the intermediate DC voltage is greater than the difference between the negative offset voltage and the intermediate DC voltage, and wherein the negative offset voltage may be applied when the difference between the negative offset voltage and the intermediate DC voltage is greater than the difference between the positive offset voltage and the intermediate DC voltage.

For subsequent PWM periods, when the Upper pair of switches are controlled to apply the positive offset voltage and wherein when the intermediate DC voltage approaches the positive intermediate target voltage, the negative offset voltage may be applied to the phase output voltage by controlling the Lower pair of switches.

For subsequent PWM periods, when the Lower pair of switches are controlled to apply the negative offset voltage and wherein when the intermediate DC voltage approaches the negative intermediate target voltage, the positive offset voltage may be applied to the phase output voltage by controlling the Upper pair of switches.

The Upper and/or Lower pair of switches may be controlled to apply a slew to the offset voltage between the positive and negative offset voltages when switching between applying the positive offset voltage and negative offset voltage.

The intermediate DC voltage may be provided via a capacitor voltage divider arranged between the positive DC input and the negative DC input. Alternatively, the intermediate DC voltage may be provided by a second DC source.

### LIST OF FIGURES

The present invention will now be described, by way of example only, and with reference to the accompanying figures, in which:

FIG. 1 shows a simplified schematic of an inverter;

FIG. 2 shows phase voltages (with respect to the 0V line) from a +DC and −DC bus at the output of the inverter of FIG. 1;

FIG. 3 shows the resulting line to line voltages at the output of the inverter of FIG. 1 as seen by the electrical machine;

FIG. 4 shows one example of a simplified layout of one solution for implementing a three-level converter, in this case a Series T-type arrangement;

FIG. 5 shows an alternative T-type arrangement for a single phase. This arrangement is a so-called parallel T-type three level converter;

FIG. 6 shows a simplified multi-phase (in this case 3-phase) converter with each phase have a three-level series t-type switch arrangement;

FIG. 7 shows an example conduction loss graph against output current for different levels of modulation (lower modulation index=lower output voltage);

FIG. 8 shows an example time plot of a phase output voltage with and without a common offset being introduced;

FIG. 9 shows a second example time plot of a phase output voltage with and without a common offset being introduced; and

FIG. 10 shows a third example time plot of a phase output voltage with and without a common offset being introduced.

### DETAILED DESCRIPTION OF THE PREFERRED EMBODIMENTS

In brief, we will describe a converter for generating a multi-phase output voltage that uses a three-level converter having Upper pairs of switches (Upper and Mid-Lower) and Lower pairs of switches (Lower and Mid-Upper) arranged between positive and negative DC input voltages and an Intermediate DC voltage. A controller controls the Upper and Lower pairs of switches using PWM over a plurality of PWM periods to generate the multi-phase AC output voltages. For each PWM period, the controller controls the respective Upper or Lower pair of switches to apply respectively either a positive or a negative offset voltage simultaneously to each of the phase outputs, wherein the positive and negative offset voltages represent an average peak to peak voltage for the phase output voltage that is offset respectively positively or negatively from the intermediate DC voltage. Advantageously, conduction losses may be reduced when the intermediate DC voltage is not the same as the average phase output voltage.

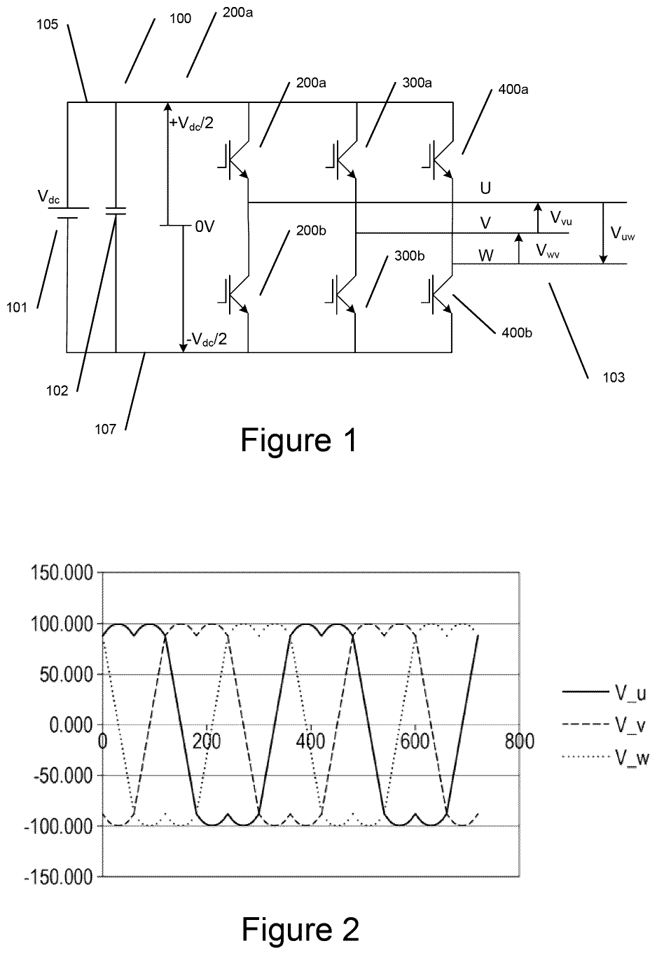

As some brief background, power converters are generally known. One example may be found in U.S. Pat. No. 8,958,222, from which FIG. 1 is taken, and shows a three phase two-level power inverter 100 for converting a DC power supply 101 to an AC output 103 which may then be connected to a load (not shown). The inverter comprises three separate phases 200, 300, 400 (also referred to as phases U, V, W respectively). Each phase includes two switches in series: 200a, 200b in phase 200/U; 300a, 300b in phase 300/V; and 400a, 400b in phase 400/W. Switches 200a, 300a and 400a are connected to the positive rail 105 (and may be referred to as the “upper” switches) and switches 200b, 300b and 400b are connected to the negative rail 107 (and may be referred to as the “lower” switches). In FIG. 1, each switch may be an IGBT (insulated gate bipolar transistor) or MOSFET (metal-oxide-semiconductor field-effect transistor) and, for each IGBT or MOSFET, an associated anti-parallel diode may be used (not shown). However, any switches with fast switching capability may be used. A control system (such as a processor) (not shown) controls the switching of the switches 200a, 200b, 300a, 300b, 400a, 400b to control the AC output of the inverter 100, often using Pulse Width Modulation (PWM) or variants of PWM. The power inverter also includes a DC bus capacitor 102, which provides a more stable DC voltage, limiting fluctuations as the inverter sporadically demands heavy current. This inverter is a so-called two-level inverter because each of the phases 200, 300, and 400 switch between two DC levels. In this case it is a DC voltage and ground, but it may also be positive DC and negative DC levels.

A sinusoidal output current can be created at AC output 103 by a combination of switching states of the six switches using PWM switching patterns. However, the inverter 100 must be controlled so that the two switches in the same phase are never switched on at the same time, so that the DC supply 101 is not short circuited. Thus, if 200a is on, 200b must be off and vice versa; if 300a is on, 300b must be off and vice versa; and if 400a is on, 400b must be off and vice versa.

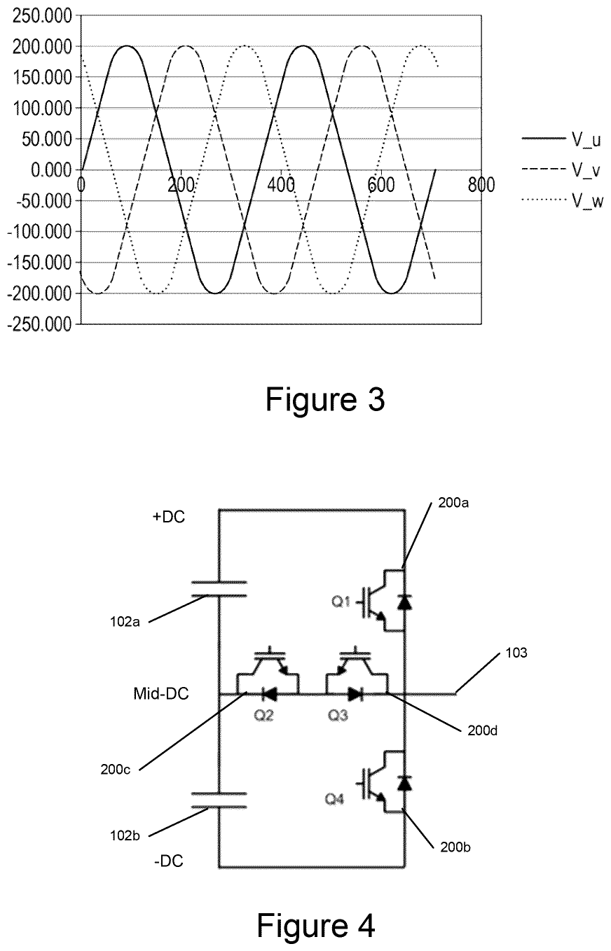

FIG. 2 shows phase voltages (with respect to the OV line shown in FIG. 1, which is half of the dc bus) with symmetric switching versus output voltage angle (with a DC bus of 250V and a 200V peak demand). FIG. 3 shows the resulting line to line voltage as seen by the electrical machine, for example a motor.

Two-level inverters switch the whole DC bus voltage every PWM period which produces large switching harmonics, and at low loads/currents conduction losses can become dominant causing increased losses in the electrical loads, for example motors or generators.

A known technique to overcome at least some of the shortcomings of the two-level converters is to use a three-level converter.

FIG. 4 shows one example of a simplified layout of one solution for implementing a three-level converter, in this case a Series T-type arrangement. This figure shows only one of the phases, in this case the equivalent of the U-phase 200 in FIG. 1. In this arrangement, the Upper (Q1) 200a and Lower (Q4) 200b are connected between the +DC and −DC supplies and provide the phase output 103. The Mid-Lower (Q3), 200d and Mid-Upper (Q2), 200c are connected between an intermediate DC voltage and the phase output 103. The intermediate DC is a DC voltage at a level between the +DC and −DC supplies. In this arrangement it is generated by a series network of capacitors 102a, 102b, although it may instead be provided from an external source. The intermediate DC voltage is not necessarily a voltage exactly in the middle of +DC and −DC, although it may be. The intermediate DC voltage may be common to all phases.

In the three-level configuration shown, the switches work in Upper and Lower pairs of switches. The Upper pair of switches comprise the Upper (Q1) 200a and Mid-Lower (Q3) 200d switches, and the Lower pair of switches comprise the Lower (Q4) 200b and Mid-Upper (Q2) 200c switches. The upper pair of switches can connect to +DC voltage or the mid-DC voltage, and the lower pair can connect to the mid-DC voltage and −DC voltage. Again, the switches are controlled by a controller and switches using PWM switching patters to generate the required phase output voltage. When the output phase voltage level is to be above the mid-DC voltage level then the upper pair is used. When the output phase voltage level is to be below the mid-DC voltage level then the lower pair is used. Each pair of switches is switching only half the DC voltage (if mid-voltage is in balance at half DC bus voltage).

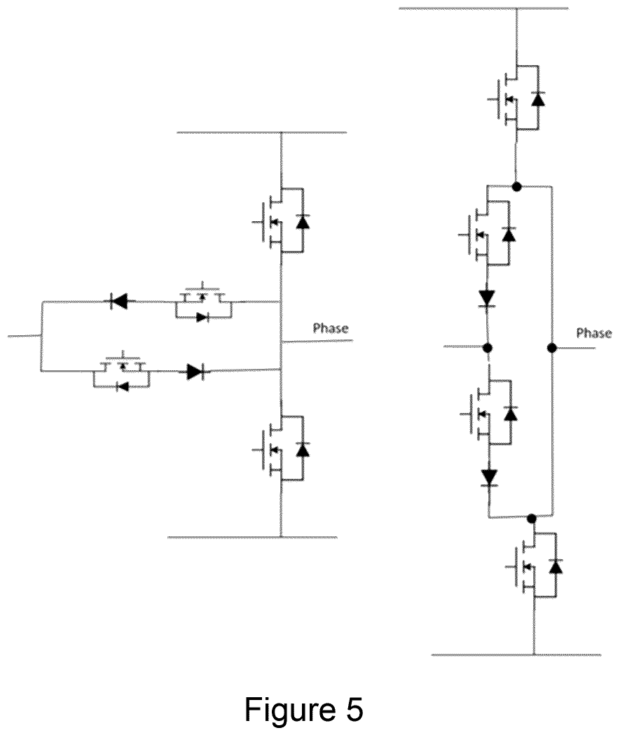

FIG. 5 shows an alternative T-type arrangement for a single phase. This arrangement is a so-called parallel T-type three level converter. The parallel T has two separate mid voltage connection paths, each has to have a blocking diode to avoid uncontrolled reverse conduction.

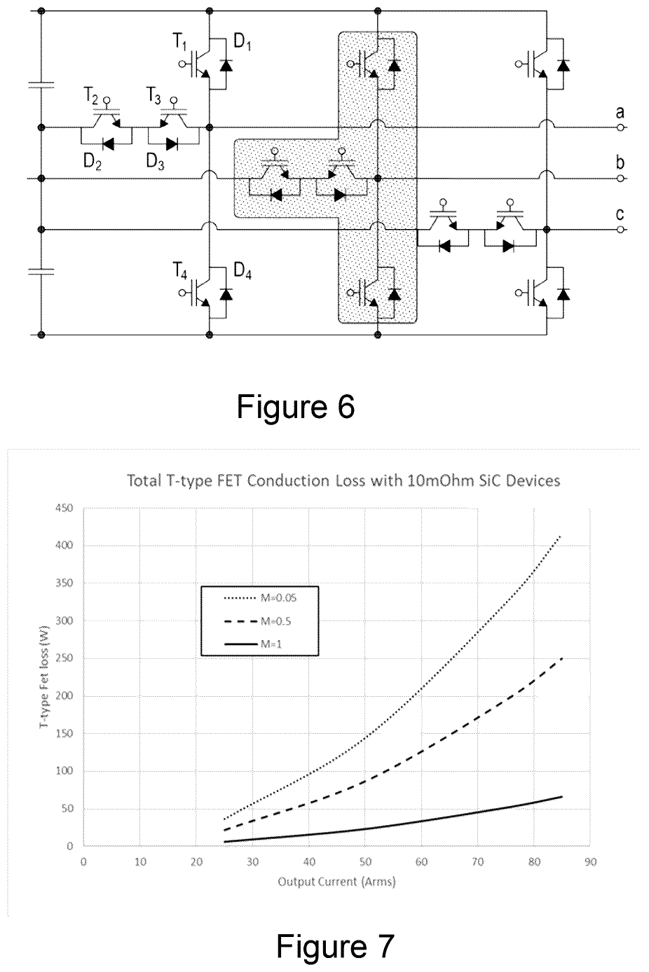

FIG. 6 shows a simplified multi-phase (in this case 3-phase) converter with each phase have a three-level series t-type switch arrangement.

Switching at half of the DC bus greatly reduces the harmonics and the losses in the load. Some simulations have shown that a ~80% reduction in WLTP (Worldwide Harmonised Light Vehicle Test Procedure) losses due to the PWM harmonics when a three-level inverter is used instead of a two-level inverter. For a standard saloon car this is about a ~5% increase in range.

In our preferred implementation of the three-level converter, both the Mid-Lower and Mid-Upper switches are rated appropriately for the required switched output voltage, which may be different to the rating of the Upper and Lower switches.

A consequence of this arrangement is that the channel resistances of the Upper and Lower switches can be much lower than the channel resistances of the Mid-Lower and Mid-Upper switches. As an example, in the preferred implementation MOSFETs are used as the power switching devices, and the channel resistance of the Upper and Lower switches (i.e. the higher rated switches) may be in the region of 1.4 mΩ, and the channel resistance of the Mid-Lower and Mid-Upper switches (i.e. the lower rated switches) may be in the region of 10 mΩ. In the example configurations shown in FIGS. 4 and 6, the Mid-Lower and Mid-Upper are arranged in series. In the example configuration shown in FIG. 5, there are blocking diodes. In all of these arrangements, the conduction losses are increased due to the devices being arranged in series.

For example, the time-averaged power loss due to conduction in a MOSFET is dependent on the duty cycle, the square of the current being conducted by the MOSFET and the resistance of the MOSFET channel. As such, it can already be seen that having a channel resistance that is higher in the lower-rated switches will impact on the conduction power losses in the switch.

FIG. 7 shows an example conduction loss graph against output current for different levels of modulation (lower modulation index=lower output voltage). It can be seen that the losses are greatly increased as the modulation index or depth is lowered (i.e. lower output voltage).

This is partly due to the variable duty cycle used in PWM schemes, where the ratio of the duty cycle between the pairs of switches (Upper and Mid-Lower; and Lower and Mid-Upper) is varied to achieve the desired output voltage for a particular PWM period. That is, as the phase output approaches the mid-DC voltage, more time is spent with the appropriate mid-level switches being on (hence conducting), and less time with the respective Upper or Lower switches being on. As the phase output voltage goes more positive or more negative (i.e. away from the mid-DC level), less time is spent with the mid-level switches being on (i.e. less time when they are conducting current), and more time is spend with the respective Upper (for more positive voltages) or Lower (for more negative voltages) switches being on.

One solution to reduce the losses within the converter when the mid-level switches are in more demand (i.e. when the switching requirements to generate the output voltage requires the mid-level switches to be on more than the respective Upper or Lower switches), is to introduce a voltage offset to the phase output voltage, which moves the average phase output voltage away from the intermediate voltage towards either the +DC bus or −DC bus. If the same voltage offset is applied to each of the output phase voltages, the electrical load does not see the offset voltage as the offset voltages on each phase cancel out in the line to line (phase to phase) voltages.

In summary, by adding a voltage offset to each of the phase voltages, this has the consequence of moving the phase voltage away from the second DC voltage and more towards the +DC or −DC bus. As such, if the offset voltage applied to the output phase voltage moves the output phase voltage towards the +DC bus, the Upper switch will need to spend more time being on compared to the Mid-Lower switch. Similarly, if the offset voltage applied to the output phase voltage moves the output phase voltage towards the −DC bus, the Lower switch will need to spend more time being on compared to the Mid-Upper switch.

The consequence of this method is a reduction in the conduction losses for the three-level converter since more time is spent with the Upper or Lower switches being on compared to the Mid-Lower or Mid-Upper switches (respectively) being on for a given phase output voltage. This is the case for various levels of modulation index (i.e. output phase voltages). However, this scheme may affect the intermediate DC voltage level.

The intermediate DC voltage may be created by capacitor voltage dividers arranged between the +DC and −DC buses. Nominally the intermediate voltage may be at DC/2, that is approximately mid-way between the +DC bus and the −DC bus, although this need not be the case and the intermediate voltage may be at a different level. In this arrangement, the intermediate DC voltage naturally balances at the average phase voltage over time. As such, spending more time with the Upper switch on (i.e. having an offset voltage that moves the phase output voltage towards the +DC bus) has the consequence of causing the intermediate DC voltage to drift gradually over time towards the +Offset voltage as more charge is added to the capacitor dividers. Similarly, spending more time with the Lower switch on (i.e. having an offset voltage that moves the phase output voltage towards the −DC bus) has the consequence of causing the intermediate DC voltage to drift gradually over time towards the −Offset voltage as the charge from the capacitor dividers is depleted. As mentioned above, the intermediate DC voltage will move towards the average of the phase voltage. The rate of drift is dependent on various factors, including, but not limited to, the size of the capacitor and current loading effects.

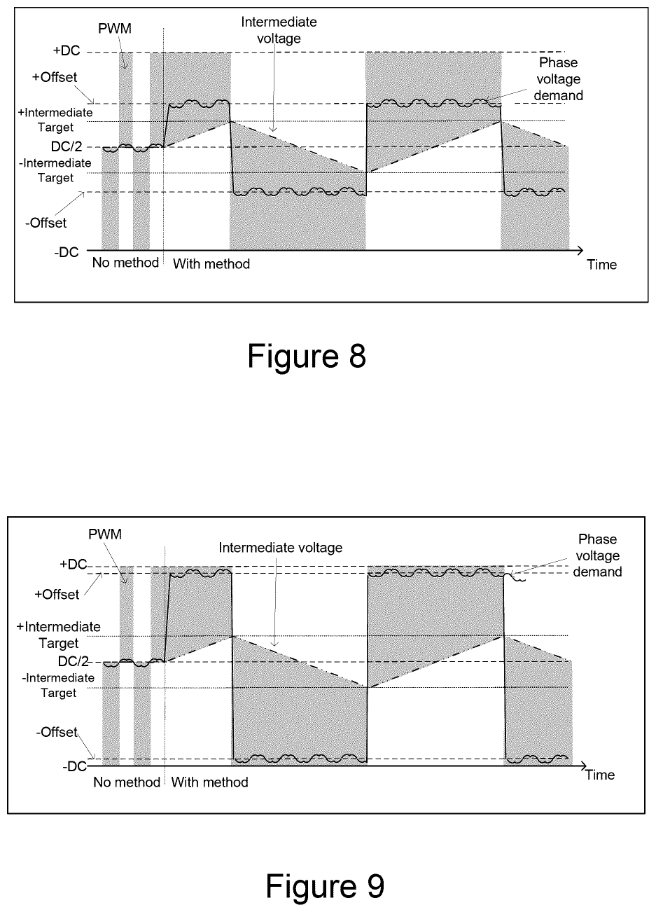

FIG. 8 shows an example time plot of a phase output voltage with and without a common offset voltages being introduced.

The diagram shows the output phase voltage over a number of output cycles. In this example, a low voltage phase output is being demanded (i.e. low modulation index). Initially there is no common offset applied, so the average phase output voltage remains at the intermediate voltage

During the period where no offset is introduced, the lower pair of switches (Lower and Mid-Upper) are used to generate the voltage when the desired phase output voltage is required to be below the intermediate voltage, and the Upper pair of switches (Upper and Mid-Lower) are used to generate the voltage when the desired phase output voltage is above the intermediate DC voltage. Since the desired phase voltage output is so low, more time will be spent with the Mid-Lower and Mid-Upper switches being on compared to the Upper and Lower switches, respectively.

Applying a common offset voltage (shown here as +Offset, since the offset voltage moves the average phase output voltage towards the +DC bus away from the intermediate voltage) by controlling the Upper and Mid-Lower switches accordingly, causes the phase output voltage to be around the +Offset level. Since the phase output voltage sits away more positively from the Intermediate DC voltage, the switching pattern required to generate the phase output voltage will require the Upper switch to be on for longer and the Mid-Lower on for shorter periods when compared to the situation where no offset voltage is applied. As such, the conduction losses are reduced when compared to no offset being applied.

In general, conduction loss is reduced when the intermediate voltage is not the same as the average phase voltage (i.e. the +Offset voltage).

However, as can be seen in the figure, this has a consequence of the Intermediate voltage drifting more positively towards the average of the phase output voltage (i.e. towards +Offset). This rise is dependent on the capacitance values generating the intermediate DC voltage, the electrical load current and the common offset used.

In order to prevent the intermediate voltage drifting too close to the offset average of the phase output voltage (which will negate the benefits of this scheme), the scheme may apply a negative DC offset i.e. a negative offset voltage that is closer to the −DC bus. In this example, the Lower and Mid-Upper switches are controlled to apply a negative offset of −Offset which causes the average phase output voltage to sit at the −Offset level. Since the phase output voltage is lower than the Intermediate voltage, the switching pattern required to generate the phase output voltage will require the Lower switch to be on for longer and the Mid-Upper on for shorter periods when compared to the situation where no offset voltage is applied. As such, the conduction losses are reduced when compared to no offset being applied.

In general, conduction loss is reduced when the intermediate voltage is not the same as the average phase voltage.

Furthermore, it can be seen that the intermediate voltage now drifts more negatively from the previous value (again it tries to stabilise at the average of the phase output voltage, which is now at the −Offset level). Similarly, to prevent the intermediate voltage drifting too close to the new average of the phase output voltage (i.e. −Offset), which would reduce or negate the benefit of the switching scheme, the scheme may apply a positive DC offset again i.e. an offset voltage that is greater than the intermediate DC voltage.

Preferably, positive and negative intermediate target values are chosen to prevent the intermediate DC voltage reaching, respectively, the closest peak of the output phase voltage. Take the example where a +Offset voltage is applied, causing the intermediate DC voltage to drift more positively towards the +Offset voltage. Once the intermediate DC voltage reaches the +Intermediate target voltage, the switching scheme is changed to apply a −Offset as discussed above, which causes the intermediate DC voltage to drift more negatively towards the −Offset voltage. Again, once the intermediate voltage reaches the −Intermediate Target voltage, the switching scheme is changed to apply a +Offset as discussed above, and the pattern repeats.

As can be seen, this alternating between a +Offset and a −Offset gives rise to a wave that approximates a triangular waveform on the intermediate voltage, where the approximate triangular wave of the intermediate DC voltage has a frequency. The frequency is dependent on capacitance, phase voltage, offset voltages, intermediate target voltages, load current, phase angle.

FIG. 9 shows a second example time plot of a phase output voltage with and without a common offset being introduced. In FIG. 9, the value of the +Offset voltage and the −Offset voltage is nearer to the +DC and −DC rails respectively. The +intermediate DC target voltage and −intermediate DC target voltages may or may not be the same.

As with the example shown in FIG. 8, the scheme in FIG. 9 applies repeating +Offset and −Offset voltages to the phase output voltage by controlling the switching patterns of the Upper pair of switches (Upper and Mid-Lower) when the phase output voltage is above the intermediate DC voltage, and the Lower pair of switches (Lower and Mid-Upper) when the phase output voltage is below the intermediate DC voltage. As with FIG. 8, the phase output voltage is relatively low (i.e. low modulation index). Again, the intermediate voltage drifts more positively when the +Offset voltage is applied to the phase output, and more negatively when the −Offset voltage is applied to the phase output voltage.

As discussed above with reference to FIG. 8, conduction loss in the switches is reduced when the intermediate voltage is not the same as the average phase voltage.

In FIG. 9, the common offset voltage is pushed towards the DC rails to maximise the peak of the intermediate voltage triangular wave and thus maximise the conduction loss reduction. In order to prevent the peak or trough of the phase output voltage hitting the DC rails (and thus push the system into over modulation), a maximum phase output voltage is chosen that is within the DC rails. This is a headroom or offset buffer voltage, and this may vary depending on the phase output voltage required (i.e. the modulation index).

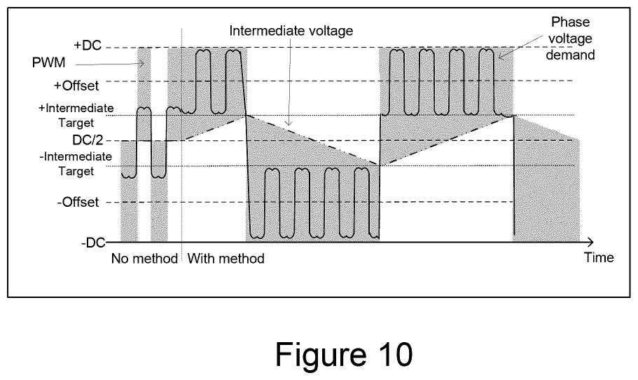

FIG. 10 shows a third example time plot of a phase output voltage with and without a common offset being introduced. In this example, the phase output voltage is increased (i.e. greater modulation index) compared to those of FIGS. 8 and 9.

As with the example shown in FIGS. 8 and 9, the scheme in FIG. 10 applies repeating +Offset and −Offset voltages to the phase output voltage by controlling the switching patterns of the Upper pair of switches (Upper and Mid-Lower) when the phase output voltage is above the intermediate DC voltage, and the Lower pair of switches (Lower and Mid-Upper) when the phase output voltage is below the intermediate DC voltage. Again, the intermediate voltage drifts more positively when the +Offset voltage is applied to the phase output, and more negatively when the −Offset voltage is applied to the phase output voltage.

As discussed above with reference to FIGS. 8 and 9, conduction loss in the switches is reduced when the intermediate voltage is not the same as the average phase voltage.

In FIG. 10, the common offset voltages (+Offset and −Offset) are lower (i.e. nearer to the mid-way point between the +DC and −DC rails) to prevent the phase output voltage hitting the DC rails.

Preferably the phase output voltage should not cross the intermediate voltage otherwise the inverter would change to the other pair of switches and thus negate the benefits of the method.

Calculating the common positive and negative offset voltage may be based on one or more of several parameters, including offset buffer voltage, an output phase voltage demand, the negative DC input voltage, the positive DC input voltage and an output load power factor. Preferably there should be sufficient headroom (the offset buffer voltage) above the peaks and below the troughs of the desired phase output voltage in order to prevent the output phase voltage hitting either of the DC rails. Preferably, the offset buffer voltage is set large enough to get as close to the desired DC rail so as to move the phase output voltage far enough away from the intermediate voltage in order to maximise the conduction loss reduction.

One example of calculating the offset voltage may be based on the desired phase output voltage (which is related to the modulation index), and a value of headroom or offset buffer voltage above or below the peak or trough of the desired phase output voltage to prevent the phase output voltage from hitting the DC rail.

With regards to the intermediate voltage, and calculating an appropriate positive and negative intermediate target voltage (that is the target voltage that the intermediate voltage is allowed to drift towards either the positive or negative offset voltages), the target may be based on one or more of the positive or negative offset voltage, the negative DC input voltage, the positive DC input voltage, the phase voltage demand (which is related to the modulation index), an intermediate target buffer voltage, and a frequency of the intermediate DC voltage. The intermediate target buffer voltage is a headroom above or below the peak or trough of the desired phase output voltage to prevent the phase output voltage from reaching or crossing the intermediate DC voltage. The intermediate target buffer voltage may be the same as the offset buffer voltage, or it may be different to the offset buffer voltage. The intermediate target buffer voltage may be zero.

Since the intermediate voltage drifts over time when using this offset voltage technique (when the intermediate DC voltage is generated from the +DC and −DC rails as described above), and since there is a benefit in reducing conduction losses when the phase voltage output is different to the intermediate DC voltage, the intermediate DC voltage may be used to determine whether or not the technique should be used in the first place. For example. when the difference between the respective +Offset voltage and −Offset voltage (which are, respectively, the average of the phase voltage outputs when a positive and negative offset voltages are applied to the phase voltage outputs) and the intermediate DC voltage is greater than a threshold, the controller may determine that there will be a benefit to using the technique and will thus control the switches appropriately to implement the +Offset and −Offset voltages as described above.

Whether or not to use the offset voltage technique described above may also or instead be determined from one or more of the following parameters: the output phase voltage demand, the DC input voltages (+DC and −DC), and the load power factor.

When the scheme is first initiated, that is for the first PWM period in which a +Offset or −Offset is to be applied, the controller may first determine which of the +Offset and −Offset voltages to apply. This determination may be based, for example, on the voltage difference between the positive offset voltage and the intermediate DC voltage, and the negative offset voltage and the intermediate DC voltage.

For example, the controller may be configured to apply the positive offset voltage when the difference between the positive offset voltage and the intermediate DC voltage is greater than the difference between the negative offset voltage and the intermediate DC voltage. Furthermore, the controller may be configured to apply the negative offset voltage when the difference between the negative offset voltage and the intermediate DC voltage is greater than the difference between the positive offset voltage and the intermediate DC voltage.

Alternatively, the controller may just implement the +Offset or the −Offset voltage, irrespective of the value of the +Offset, −Offset and intermediate DC voltages.

Once the scheme has been initiated, that is for subsequent PWM periods, the determination of which Offset voltage to apply is as described above with reference to the intermediate DC voltage approaching the respective positive or negative intermediate target voltages.

When switching between applying a +Offset voltage and a −Offset voltage, i.e. when switching between using the Upper pair of switches and the Lower pair of switches respectively, preferably a slew is applied to the switching scheme. This aims to minimise NVH (Noise, Vibration and Harshness) issues that may arise from rapid changes in the phase output voltage during the transition between +Offset and −Offset conditions.

Whilst we have described examples where the intermediate DC voltage is generated from the +DC and −DC rails (for example using voltage dividing capacitors), the intermediate DC voltage may be provided by a second DC input voltage source. In one example, the second DC input voltage source may be capable of sourcing and sinking current during the periods in which the +offset and −offset voltages are applied to the phase voltage output, resulting in the intermediate DC voltage remaining constant. In such a case, the decision of which of the +Offset and −Offset voltages to apply may be based on other parameters, for example based on the characteristics of the switches being used, noise considerations, switch thermal characteristics and other parameters.

Alternatively, the second DC input voltage source may be configured to provide a variable or varying intermediate DC voltage, in which case the controller determines which of the +Offset and −Offset to apply as described above with the varying intermediate DC voltage.

The second DC input voltage source may for example be provided by a centre-tap from a battery pack supplying the +DC and −DC rails. In such a configuration, the +Offset and −Offset voltages may be applied alternately to control the charging and discharging of the different halves of the battery pack depending on the desired performance and state of the battery pack.

Whilst we discuss and exemplify three-phase voltage generation, the described three-level converter works also for higher number of phase outputs. As such, the techniques work also with a multi-phase output voltage generation.

No doubt many other effective alternatives will occur to the skilled person. It will be understood that the invention is not limited to the described embodiments and encompasses modifications apparent to those skilled in the art lying within the scope of the claims appended hereto.

1. A converter for generating a multi-phase voltage for powering an electrical machine, comprising:
inputs for receiving a positive DC input voltage and a negative DC input voltage;
a plurality of AC outputs, one per phase, for outputting a multi-phase AC output voltage for driving an electrical machine;
for each phase, a plurality of switches arranged between the DC inputs and the respective AC phase output in a t-type arrangement, the t-type arrangement comprising an upper switch coupled between a positive DC input and the respective AC phase output, a lower switch coupled between the respective AC phase output and negative DC input, and a mid-upper switch and a mid-lower switch coupled between the AC phase output and an intermediate DC voltage, the switches being arranged in respective upper and lower pairs of switches, the upper pair comprising the upper and mid-lower switches and the lower pair of switches comprising the lower and mid-upper switches, and the intermediate DC voltage being a voltage between the positive and negative DC input voltages;
an input for receiving data representing a required phase voltage demand for the electrical machine; and
a controller for controlling each of the switches using Pulse Width Modulation (PWM) over a plurality of PWM periods to generate the multi-phase AC output voltages for an electrical machine,
wherein the controller is configured, for each PWM period, to:
control the respective Upper or Lower pair of switches to apply respectively either a positive or a negative offset voltage simultaneously to each of the phase outputs, wherein the positive and negative offset voltages represent an average peak to peak voltage for the phase output voltage that is offset respectively positively or negatively from the intermediate DC voltage.

2. A converter according to claim 1, wherein controlling the respective Upper or Lower pair of switches to apply respectively the positive or negative offset voltage comprises:
determining the positive and negative offset voltages to apply to each of the phase output voltages based on one or more of an offset buffer voltage, an output phase voltage demand, the negative DC input voltage, the positive DC input voltage and an output load power factor, wherein the offset buffer voltage represents a minimum voltage difference between a peak phase output voltage and the respective positive and negative DC input voltages.

3. A converter according to claim 2, wherein controlling the respective Upper or Lower pair of switches to apply respectively the positive or negative offset voltage comprises:
determining a positive and negative intermediate target voltage based on one or more of the positive or negative offset voltage, the negative DC input voltage, the positive DC input voltage, the phase voltage demand, an intermediate target buffer voltage, and a frequency of the intermediate DC voltage, wherein the positive and negative intermediate target voltages represent a target voltage deviation of the intermediate DC voltage.

4. A converter according to claim 2, when the controller applies the positive or negative offset voltage when a difference between the respective positive or negative offset voltages and the intermediate DC voltage is greater than a threshold voltage.

5. A converter according to claim 3, wherein the controller determines which of the positive offset or negative offset voltages to apply for a first PWM period based on the voltage difference between the positive offset voltage and the intermediate DC voltage, and the negative offset voltage and the intermediate DC voltage.

6. A converter according to claim 5, wherein when the controller applies the positive or negative offset voltage for the first PWM period, the controller is configured to apply the positive offset voltage when the difference between the positive offset voltage and the intermediate DC voltage is greater than the difference between the negative offset voltage and the intermediate DC voltage, and wherein the controller is configured to apply the negative offset voltage when the difference between the negative offset voltage and the intermediate DC voltage is greater than the difference between the positive offset voltage and the intermediate DC voltage.

7. A converter according to claim 5, wherein, for subsequent PWM periods, when the controller controls the Upper pair of switches to apply the positive offset voltage and wherein when the intermediate DC voltage approaches the positive intermediate target voltage, the controller is configured to apply a negative offset voltage to the phase output voltage by controlling the Lower pair of switches.

8. A converter according to claim 5, wherein, for subsequent PWM periods, when the controller controls the Lower pair of switches to apply the negative offset voltage and wherein when the intermediate DC voltage approaches the negative intermediate target voltage, the controller is configured to apply a positive offset voltage to the phase output voltage by controlling the Upper pair of switches.

9. A converter according to claim 7, wherein when the controller switches between applying the positive offset voltage and negative offset voltage, the controller controls the Upper and/or Lower pair of switches to apply a slew to the offset voltage between the positive and negative offset voltages.

10. A converter according to claim 1, wherein the intermediate DC voltage is provided by capacitor voltage dividers arranged between the positive DC input and the negative DC input.

11. A converter according to claim 1, wherein the intermediate DC voltage is provided by a second DC source.

12. A method for generating a multi-phase voltage for powering an electrical machine, comprising:
receiving a positive DC input voltage and a negative DC input voltage;
receiving data representing a required phase voltage demand for the electrical machine;
controlling a plurality of switches using Pulse Width Modulation (PWM) over a plurality of PWM periods to generate the multi-phase AC output voltages for an electrical machine, the plurality of switches being arranged in a plurality of groups, one per phase, wherein for each phase the group of switches are arranged between the DC inputs and a respective AC phase output in a t-type arrangement, the t-type arrangement comprising an upper switch coupled between a positive DC input and the respective AC phase output, a lower switch coupled between the respective AC phase output and negative DC input, and a mid-upper switch and a mid-lower switch coupled between the AC phase output and an intermediate DC voltage, the switches being arranged in respective upper and lower pairs of switches, the upper pair comprising the upper and mid-lower switches and the lower pair of switches comprising the lower and mid-upper switches, and the intermediate DC voltage being a voltage between the positive and negative DC input voltages; and
outputting the multi-phase AC output voltages, for driving an electrical machine, wherein for each PWM period, controlling a plurality of the switches comprises:
controlling the respective Upper or Lower pair of switches to apply respectively either the positive or negative offset voltage simultaneously to each of the phase outputs, wherein the positive and negative offset voltages represent an average peak to peak voltage for the phase output voltage that is offset respectively positively or negatively from the intermediate DC voltage.

13. A method according to claim 12, wherein controlling the respective Upper or Lower pair of switches to apply respectively the positive or negative offset voltage comprises:
determining the positive and negative offset voltages to apply to each of the phase output voltages based on one or more of an offset buffer voltage, an output phase voltage demand, the negative DC input voltage, the positive DC input voltage and an output load power factor, wherein the offset buffer voltage represents a minimum voltage difference between a peak phase output voltage and the respective positive and negative DC input voltages.

14. A method according to claim 13, wherein controlling the respective Upper or Lower pair of switches to apply respectively the positive or negative offset voltage comprises:
determining a positive and negative intermediate target voltage based on one or more of the positive or negative offset voltage, the negative DC input voltage, the positive DC input voltage, the phase voltage demand, an intermediate target buffer voltage, and a frequency of the intermediate DC voltage, wherein the positive and negative intermediate target voltages represent a target voltage deviation of the intermediate DC voltage.

15. A method according to claim 13, when the positive or negative offset voltage is applied when a difference between the respective positive or negative offset voltages and the intermediate DC voltage is greater than a threshold voltage.

16. A method according to claim 14, wherein which of the positive offset or negative offset voltages to apply for a first PWM period is based on the voltage difference between the positive offset voltage and the intermediate DC voltage, and the negative offset voltage and the intermediate DC voltage.

17. A method according to claim 16, wherein when the positive or negative offset voltage is applied for the first PWM period, the positive offset voltage is applied when the difference between the positive offset voltage and the intermediate DC voltage is greater than the difference between the negative offset voltage and the intermediate DC voltage, and wherein the negative offset voltage is applied when the difference between the negative offset voltage and the intermediate DC voltage is greater than the difference between the positive offset voltage and the intermediate DC voltage.

18. A method according to claim 16, wherein, for subsequent PWM periods, when the Upper pair of switches are controlled to apply the positive offset voltage and wherein when the intermediate DC voltage approaches the positive intermediate target voltage, the negative offset voltage is applied to the phase output voltage by controlling the Lower pair of switches.

19. A method according to claim 16, wherein, for subsequent PWM periods, when the Lower pair of switches are controlled to apply the negative offset voltage and wherein when the intermediate DC voltage approaches the negative intermediate target voltage, the positive offset voltage is applied to the phase output voltage by controlling the Upper pair of switches.

20. A method according to claim 18, wherein the Upper and/or Lower pair of switches are controlled to apply a slew to the offset voltage between the positive and negative offset voltages when switching between applying the positive offset voltage and negative offset voltage.

21. (canceled)

22. (canceled)
